(19) United States
(12) Patent Application Publication
(10) Pub. No.: US 2016/0100325 A1
(43) Pub. Date: Apr. 7, 2016

(54) WIRELESS NETWORK MONITORING DEVICE

(71) Applicant: GOOGLE INC., Mountain View, CA (US)

(72) Inventor: Christopher Lee HAIN, Sunnyvale, CA (US)

(73) Assignee: GOOGLE INC., Mountain View, CA (US)

(21) Appl. No.: 14/165,001

(22) Filed: Jan. 27, 2014

(51) Int. Cl. H04W 24/10

(52) U.S. Cl. CPC H04W 24/10

(57) ABSTRACT

A wireless network monitoring and reporting unit is described herein. The unit runs tests in a given order to detect whether certain networking low-level requirements are met (e.g., whether a DHCP lease has been obtained and whether DNS is functional). Certain base tests are may be included for different connections, regardless of the connection's configuration. In the event of a base test failure, higher level tests may be skipped. The wireless network monitoring and reporting unit may provide improvements in the ability to accurately detect and report wireless connectivity problems, and to monitor and report wireless network performance at a given location.

### BACKGROUND

Wireless networks, and particularly enterprise wireless networks operating on WiFi protocols, may be difficult to monitor and troubleshoot. Wireless networks tend to be more complicated that wired networks, and typically involve the use of multiple different Service Set Identifiers (SSIDs), authentication types, operating frequencies, access permissions, and routing policies. Traditional network monitoring practices may fail to identify problems with a wireless network and alert network operators.

Furthermore, troubleshooting known wireless network performance and connectivity issues in a remote enterprise office may pose a significant challenge for network administrators. Typically, “wired” network equipment like switches and routers include built-in troubleshooting functionality that closely mimics the “wired” end user experience. This gives wired network administrators the ability to reproduce and investigate issues first hand. However, wireless networking equipment typically does not provide the same ability to execute tests from the end-user perspective (e.g., connected via a wireless connection at the physical layer).

As a result, traditional network monitoring solutions typically report “network device-level” problems, but may fail to provide a deeper view into the client device's connectivity to the network. For example, a traditional network monitoring tool may be capable of informing a network administrator whether a particular network device is functioning (e.g., the device is powered on and the network transmitter is active), but not, for example, whether a user device at a particular site can successfully utilize a given wireless local area network (WLAN).

Accordingly, network administrators may rely on third parties, such as end users, to execute tests on the client device and report results back second-hand. This type of troubleshooting may be problematic because the network administrator may need to rely on the observations of an end user who may not have networking expertise.

### SUMMARY

Exemplary embodiments may include methods, mediums, and systems for monitoring the status and performance of a wireless network, for alerting network administrators of potential problems, and for allowing network administrators to troubleshoot network problems remotely from a “client's-eye-view.” Maintaining such a perspective may be accomplished by deploying a network tool as a wireless client directly in the wireless network. The network tool may continuously gather data, report the data to a central repository, and generate status-based alerts. Furthermore, the network tool may support interaction with a remote network administrator, allowing the remote administrator to log into the network tool and cause the network tool to carry out tests, thus allowing the administrator to troubleshoot the network from the perspective of a client.

According to an exemplary embodiment, a network monitoring system may be provided. The network monitoring system may include a transmitter for directly connecting to a wireless network as a client of the wireless network. For example, the system may include two antennas for connecting to the wireless network and retrieving the configuration data.

The system may further include a memory for storing one or more tests for determining a status of the wireless network, results of the one or more tests, and configuration data for the one or more tests. The configuration data may include performance metrics for the tests, and may define which performance metrics must be met to result in a test success.

The system may further include a processor. In some embodiments, the processor may request the configuration data from a cloud storage device located outside the wireless network. The processor may further authenticate the system with the cloud storage device.

The processor may be configured to execute a command to run the one or more tests according to the configuration data. The one or more tests may be run in a predetermined order.

The tests may include at least one base test and at least one high level test dependent on a successful result of the base test. If the processor determines that the base test has failed, the processor may skip the high level test and stores a result indicating that the high level test failed due to the failure of the base test. If the processor determines that the base test has succeeded, then the processor may run the high level test based on the success of the base test.

The processor may further be configured to generate results for the one or more tests, and store the result of each test locally in the memory. The processor may further be configured to parse the results to determine if each test was successful, and transmit the results to a storage device located outside the wireless network.

The system may upload the results of the tests to a cloud storage device located outside the wireless network. The cloud storage may retrieve the results of the test from a local memory. The system may further include a central server configured to retrieve the results of the tests from the cloud storage and perform a trend analysis on the results.

In another embodiment, a network troubleshooting system may be provided. The network troubleshooting system may be an embedded system.

The network troubleshooting system may include a memory for storing one or more tests for determining a status of a wireless network. The system may connect to the wireless network as a client of the wireless network. For example, the system may connect to the wireless network using two antennas. The network troubleshooting system may further include an interface for allowing a remote connection from outside the wireless network.

The system may further include a processor. The processor may be configured to receive an instruction originating outside the wireless network via the interface. The instruction may request that a specified test be performed. The processor may perform the test to generate test results and forward the test results in response to the request.

The processor may further be configured to perform one or more tests of the wireless network at predetermined time intervals, and enter a sleep mode between the predetermined time intervals. In response to receiving the instruction to execute a specified test, the processor may wake up from the sleep mode.

In exemplary embodiments, the memory of the system may store a lock flag indicating that a test is being performed on the wireless network. The processor may be configured to check for the lock flag before performing any action that would tear down an existing network connection.

In anther embodiment, a method of network monitoring may include retrieving, using a processor of an embedded system, configuration data. The configuration data may include device data for configuring the embedded system, network connection data for connecting to one or more wireless networks, and test configuration data for performing one or more tests on the one or more wireless networks. The configuration data may further include performance metrics for determining whether a given test was successful.

Retrieving the configuration data may involve establishing a connection to a cloud storage device, identifying the embedded system, and retrieving a configuration file assigned to the embedded system from the cloud storage device.

The method may further include connecting to a first wireless network from among the one or more wireless networks specified in the network connection data. The embedded system may connect to the wireless network as a client of the wireless network.

The method may further include performing the one or more tests specified in the test configuration data to generate results, merging the results, storing the results in a local storage of the embedded system; and transmitting the results to a location outside of the first wireless network.

In addition to running periodic tests, the method may further include receiving an instruction to perform a specified test from a location outside of the first wireless network, performing the specified test to generate specified test results, and transmitting the specified test results to the location outside of the first wireless network.

Accordingly, exemplary embodiments include methods and systems for monitoring and troubleshooting a wireless network. Exemplary embodiments may also include non-transitory computer-readable mediums storing instructions for performing the acts described herein. Because the exemplary methods and systems connect to the wireless network as a client of the wireless network, the tests results originating at the systems provide a client's-eye-view into the wireless network.

### BRIEF DESCRIPTION OF THE DRAWINGS

FIG. 1 depicts an overview of network elements for use with exemplary embodiments.

FIG. 2 is a flowchart depicting an exemplary method for performing system monitoring in a wireless network.

FIG. 3 is an exemplary interface displaying wireless network performance results.

FIG. 4A depicts a side view of a constructed wireless network monitor according to an exemplary embodiment.

FIG. 4B is a top view of some of the internal components of the wireless network monitor of FIG. 4A.

FIG. 4C is a rear view of some of the internal components of the wireless network monitor of FIG. 4A.

FIG. 5 is an exemplary electronic device suitable for use with exemplary embodiments.

### DETAILED DESCRIPTION

Exemplary embodiments provide a small form factor embedded system for deployment in a wireless network. The device may operate as a wireless network monitoring, alerting, and remote troubleshooting tool. The device may be relatively small in size (e.g., including two antennas and related hardware) so that the device may be deployed in a manner similar to that of a consumer WiFi access point. The device may allow for network monitoring and testing from the perspective of an end user of the wireless network, thereby providing improved insight into the functioning of the wireless network .

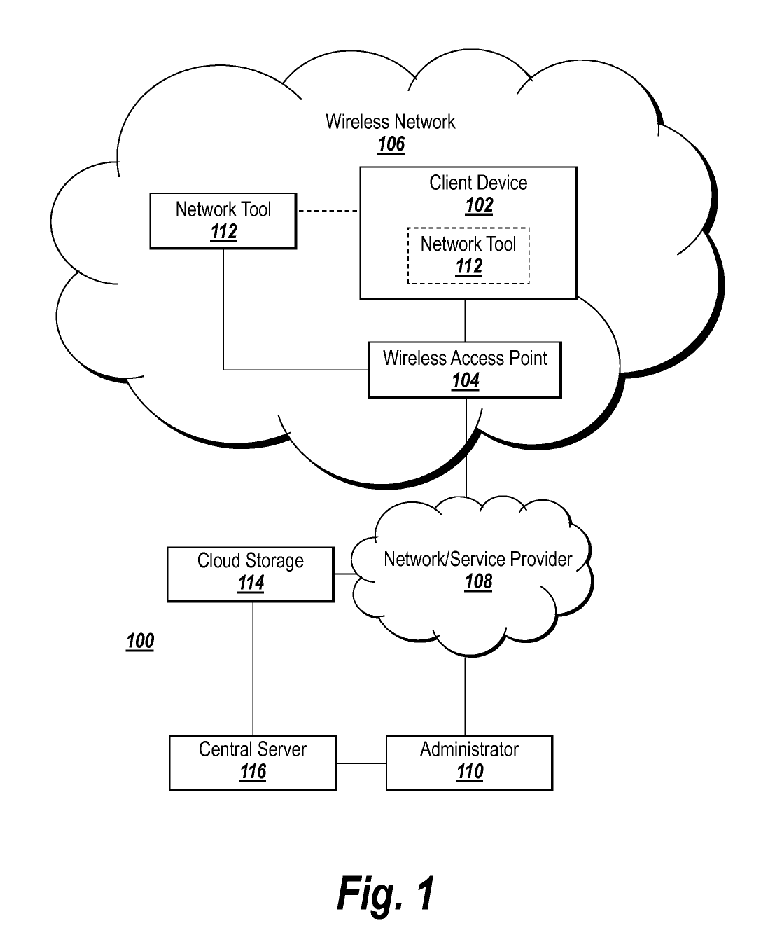

FIG. 1 depicts an exemplary environment 100 in which such a wireless network monitoring, alerting, and remote troubleshooting tool may be deployed. The environment 100 may include a client device 102 capable of accessing a wireless network 106. The client device may be, for example, a computer, a tablet, a phone, a server, an internet-enabled device, or any other suitable device having the capability to send and/or receive data, at least in part, wirelessly.

The client device 102 may access the wireless network 106 by connecting to one or more wireless access points (WAPs) 104. The WAP 104 may be any device suitable for establishing and/or managing a wireless connection between the client device 102 and the wireless network 106. The WAP 104 may generate the wireless network and may allow the wireless network to be configured. The WAP 104 may include one or more wireless transmitters and/or one or more wired transmitters.

The wireless network 106 may be any network that transmits information without the use of wires. For example, the wireless network 106 may transmit data using radio waves, light waves, pressure waves (e.g., acoustic pressure waves) or any other type of suitable wireless transmission medium. The wireless network 106 may be, for example, a Wireless Local Area Network (WLAN) which the client device 102 may access through radio signals operating under the Institute of Electrical and Electronics Engineers' (IEEE) 802.11 standards.

The WAP 104 may also connect to a network (such as a wired network) or a service provider (such as an Internet Service Provider, or “ISP”). The network/service provider 108 may connect the wireless network 106 to one or more other entities, such as the Internet and/or a remotely-located administrator 110. The connection between the WAP 104 and the network/service provider 108 may be a wired connection.

One or more network tools 112 may be deployed at selected locations to access the wireless network 106. For example, the one or more network tools 112 may be deployed at predetermined locations selected based on the locations of the WAPs 104. As shown in FIG. 1, the network tool 112 may be a standalone device, or may optionally be integrated with the client device 102. The network tool 112 may analyze traffic in the network without the need for additional hardware to generate test traffic or perform data collection.

The network tool 112 may attempt to connect to the wireless network 106 in the same manner as the client device 102. The network tool 112 may include logic for testing the wireless network at regular intervals and reporting the results of the tests to the administrator 110.

The network tool 112 may send the results of the tests to a central server 116, which may aggregate the test results from multiple network tools 112 and/or over multiple time periods to analyze trend data. Accordingly, the network tool 112 may serve as one unit in a larger performance monitoring system, which provides a holistic view of wireless network health throughout a given region, site, building, or floor.

Further, the network tool 112 may include access logic so that the administrator 110 can take control of the network tool 112 and conduct network test manually, in order to better troubleshoot the wireless network 106.

The network tool 112 may include local storage for storing the results of the tests. Accordingly, the network tool 112 may store all test result data locally to facilitate continued data collection in the event of isolation from the central server 116 (e.g., due to upstream network failure). The local storage may store a round-robin database (RRD), and a separate RRD may be created for each test. In one embodiment, the RRD may be sized to store values for seven days in the past. Each test may be responsible for defining a name for the RRD, although other parameters (e.g., update interval, total rows, etc) may be defined statically and stored in the local storage of the network tool.

The network tool 112 may also have access to central data storage in the central server 116. Limited hardware capabilities on the network tool 112, and the potential for the network tool 112 to be deployed in a location unreachable directly from outside networks may make the use of a central data repository for any data interaction (e.g. reporting, alerting) an attractive option. An example of a suitable central server is the Nagios by Nagios Enterprises of Saint Paul, Minn.

However, in some cases the central server 116 may not be accessible from outside the local network where the central server 116 is located. Further, accessing the central server 116 directly from the network tool 112 may create security risks without much correspondent benefit.

Accordingly, the network tool 112 may first upload test results and data to cloud storage 114, and the central server 116 may retrieve the test results and data from the cloud storage 114. Thus, the cloud storage 114 may act as a safe zone for passing data between network tools 112 on untrusted wireless networks 106, and for monitoring/reporting systems inside trusted wireless networks 106.

An example of such cloud storage 114 is the Appengine Datastore from Google, Inc. of Mountain View, Calif. Cloud storage 114 may be particularly useful in the context of remote wireless network administration because the cloud storage 114 easily scales and provides global reachability, which may allow for a connection to remote devices distributed around the world. In one embodiment, the cloud storage 114 may store seven days of historic data from the network tool 112.

The historic data may be retrieved from the cloud storage 114 and stored in the central server 116 for long term storage, trend analysis, alerting, and other actions. For example, the network tool 112 and/or the central server 116 may include logic for creating alerts upon the occurrence or non-occurrence of predefined events (e.g., test failures) and for sending the alerts to the administrator 110.

By using local storage in combination with the cloud storage 114 and central server 116, the network tool 112 may continue to provide limited services even in the event that portions of the system are cut off from the network tool 112 (e.g., due to upstream network failures). For example, in the case that the central server 116 becomes unavailable, the network tool 112 can continue to upload data to the cloud storage 114, where the data can be retrieved by the central server 116 when the central server 116 again becomes operational. In the event that the network tool's 112 connection to the cloud storage 114 is severed, the network tool 112 may continue to store test data in the network tool's 112 local storage, thereby facilitating continued data collection in the event of isolation from other components of the system. When the cloud storage 114 again becomes operational, the cloud storage 114 may backfill any missing data in the cloud storage 114 by querying the local storage of the network tool 112.

It is noted that, although FIG. 1 depicts the administrator 110 as being outside the wireless network 106, it is not necessary for the administrator 110 to be located remotely. Although the administrator 110 may use the presently-described network tool 112 to remotely administer the wireless network 106, exemplary embodiments also provide useful functionality for administrators who have direct access to (e.g., are present in) the wireless network 106.

Moreover, the network tool 112 need not exist in only a single wireless network 106. For example, the network tool 112 may be capable of connecting to multiple different wireless networks 106 and monitoring each wireless network 106. Each wireless network 106 may be associated with an identifier, such as a service set identifier (SSID), which devices may use to access the wireless network 106. In the even that multiple wireless networks 160 are within range of the network tool 112, the network tool 112 may connect to each wireless network 106 in turn, using the SSID associated with each wireless network 106.

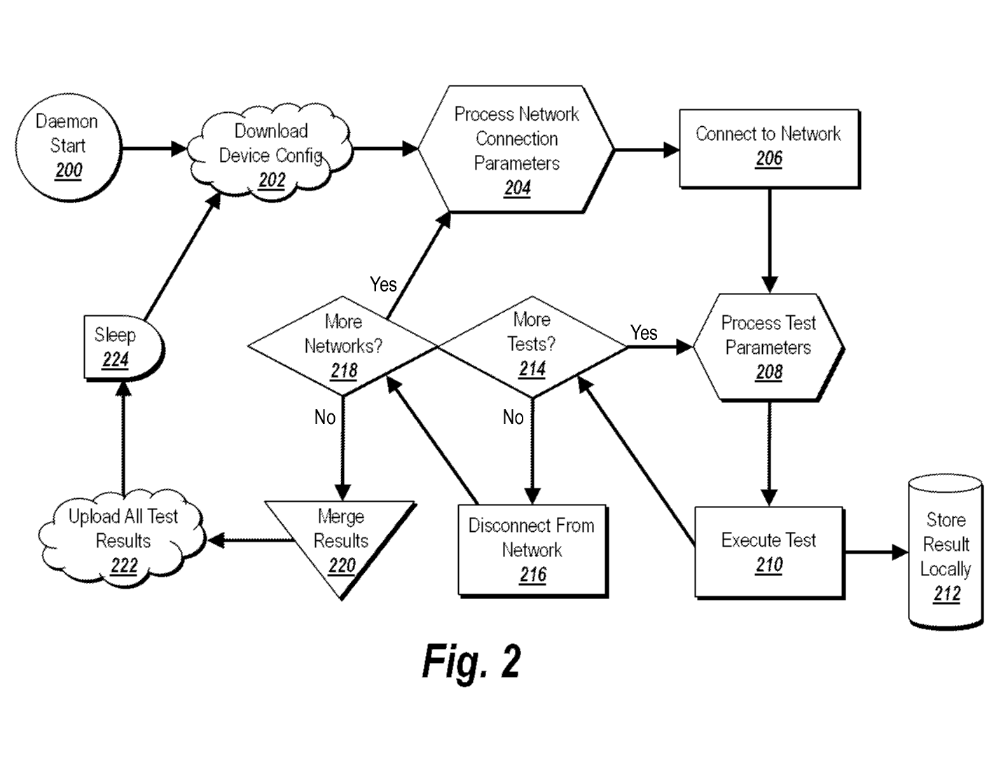

Accordingly, the network tool 112 may connect to one or more wireless networks 106 and perform one or more tests in the wireless networks 106. FIG. 2 depicts a flowchart of an exemplary method performed by the network tool 112 in order to monitor one or more wireless networks 106.

At step 200, the network tool 112 may initiate processing. For example, the networking tool 112 may execute one or more daemons. In one embodiment, the daemons may be one or more Python scripts running on the network tool 112.

At step 202, the network tool 112 may download configuration data for configuring the network tool 112. For example, the network tool 112 may download the configuration data from the cloud storage 114. For example, the configuration data may be in the form of a json encoded configuration file stored in the cloud storage 114. The network tool 112 may identify itself (e.g., using a media access control or “MAC” address), and the cloud storage 114 may use the identification to determine which configuration file to serve to the network tool 112.

The network tool 112 may attempt to download the configuration data at the beginning of each test sequence. In the event of a failure to download the configuration data, the network tool 112 may use the most-recently downloaded configuration data and/or may resort to default pre-programmed configuration data. Accordingly, testing may still occur if the network tool 112 is isolated from outside networks.

The configuration data may be specific to an individual network tool 112, and may include system, target network, and test attributes.

System configuration parameters may include parameters relating to the network tool 112. Such parameters may include, for example, a hostname and a device location. The system configuration parameters may be used to tag result values with metadata that allows status and/or performance reports for a given device or location.

Target network configuration parameters may include configuration parameters relating to the wireless network 106. Such parameters may include, for example, a list of wireless networks 106 to be tested by the network tool 112. Each target network configuration parameter may include parameters for connecting to the wireless network 106 (e.g., SSID, op-mode, PSK, network password, etc). In exemplary embodiments, the target network configuration parameters may provide the network tool 112 with the ability to support any authentication methods and radio frequencies in use on extended service sets (ESS) in the network.

Test configuration parameters may include parameters related to the tests to be conducted by the network tool 112. Such parameters may include, for example, a list of tests to be executed, attributes such as test type (e.g., 802.11Auth, 802.11Assoc, ping, http), the target of the test (e.g., which host to ping, a URL for HTTP requests), and a test protocol (e.g., IPv4, IPv6, etc.). Particular tests may have additional attributes (e.g., DNS testing may include a record type to query, etc.).

When retrieving the configuration data from the cloud storage 114, access control may be used to provide a more secure transaction. For example, the network tool 112 may be authenticated in some manner. In one embodiment, a unique character string (e.g., 30 characters long) may be generated and stored locally on the network tool 112. The unique character string may also be stored in the network tool's 112 configuration file on the cloud storage 114. This unique character string may be presented by the network tool 112, in addition to the network tool's 112 MAC address, when performing transactions or API interactions (e.g., downloading the configuration data, storing test results, etc.). Before transmitting the configuration file from the cloud storage 114, the unique character string may be stripped out of the configuration file for security purposes and transmission efficiency. When transmitting the unique characters string from the network tool 112 to the cloud storage 114, SSL and HHTPs may be utilized in order to provide a more secure transmission.

In the event of a mismatch between the unique character string and the MAC address may result in an error (e.g., an HTTP 401 error). In addition to providing authentication capabilities, this technique also allows a compromised or lost network tool 112 to have its access to the cloud storage 114 revoked by changing or deleting the character string (or the configuration data).

At step 204, the network tool 112 may read the network configuration parameters for all monitored networks from the configuration data downloaded at step 202, and may make any necessary hardware and/or software configuration changes to allow the network tool 112 to comply with the network configuration data provided.

At step 206, the network tool 112 may attempt to connect to a wireless network 106 as a client of the wireless network 106. If there are multiple wireless networks 106 in the list provided with the configuration parameters in step 202, then the network tool 112 may attempt to connect to one of the wireless networks 106 (e.g., the first wireless network 106 in the list). The network tool 112 may utilize any configuration parameters provided at step 202 (e.g., SSID, network password) in order to attempt to establish a connection with the wireless network 106.

For example, the network tool 112 may use the target network configuration parameters to configure a WPA Supplicant utility to connect to the wireless network 106. In one embodiment, the network tool 112 may perform the following sequence of events to create and destroy a network connection: configure a wpa_supplicant.conf file, create a wireless interface, start the wpa_supplicant, execute the tests (step 210), stop the wpa_supplicant, and bring down the wireless interface (step 216).

In one embodiment, an attempt to connect to a wireless network may entail destroying any existing network connections. Accordingly, alternative means may be provided to prevent the network tool 112 from disconnecting manual users (e.g., the administrator 110). For example, the network tool 112 may check for a network lock that may be set up by the manual user indicating the occurrence of manual testing. In the event that such a network lock is present, the network tool 112 may refrain from attempting to perform an action that would tear down the existing network connections (e.g., disconnecting or disassociating from the wireless network).

If the network tool 112 is unable to connect to the wireless network 106, then the network tool 112 may report the failure back to the central server 116, the cloud storage 114, and/or the administrator 110. For example, the network tool 112 may generate a network connection failure alert.

If the connection succeeds, then at step 208, the network tool 112 may read the test configuration parameters from the configuration data downloaded at step 202. The network tool 112 may make any necessary hardware and/or software configuration changes to allow the network tool 112 to comply with the network configuration data provided.

At step 210, the network tool 112 may execute a test from the list of tests in the configuration data downloaded at step 202. The network tool 112 may determine whether the test (which may be, for example, executed in the form of a command line command) should be provided with any mandatory or optional parameters, which may be specified in the configuration data. If so, the network tool 112 may cause the test to be executed with the mandatory or optional parameters. In an exemplary embodiment, the tests may be executed by a script (such as a Python script) running as a daemon on the network tool 112.

The network tool 112 may run tests in a specific order to ensure that low level requirements are met before testing high level requirements (e.g. testing that a DHCP lease has been obtained and the DNS is functional before pinging www.google.com). Certain tests may be included for every connection, regardless of configuration (referred to as base tests below). In the event of any base test failure, higher level tests may be skipped.

Each test may follow a basic sequence. For example, the test may involve configuring parameters (including any necessary static routes), executing a command to initiate the test, parsing the results of the test, and storing the results of the test. Each test type may be defined as its own module or class, and additional test types may involve the creation of a new self-contained module.

The test may generate result data representing test results. The test results may be compared to predetermined triggers or performance metrics associated with the test. An example of a performance metric may be, for example, round-trip time and packet loss percentages for a ping test, the time between a DNS request and response, etc. If the test results meet the performance metric or meet a predetermined trigger condition, then the network tool may generate an alert and forward the alert to the central server and/or the network administrator. In one embodiment, the alert may take the form of a Simple Network Management Protocol (SNMP) trap sent to the central server.

In one embodiment, there may be four categories of test results: success, failure, undefined, and failure due to lower level failure. Each test may define its own metrics or thresholds as to what result data would cause the results to be categorized into each of the four categories.

A result of “success” may indicate that the test was executed and passed. For example, a success in a ping test may indicate that the ping received a response. A success in a dhcp test may indicate that an address was successfully received. In some embodiments, success does not necessarily imply that the results of a performance metric met a certain threshold (e.g., round trip time for a ping test was below a certain threshold).

A result of “failure” may indicate that the test was not successful without implying. For example, a failure in a ping test may indicate 100% packet loss. A failure in a dhcp test may indicate that no lease offer was received. In some embodiments, a failure does not imply that the results of the test's performance metric were not in line with a particular threshold.

A result of “undefined” may indicate that test execution failed (or did not occur) due to a system level problem. For example, if the parameters of the test were incorrectly defined in the configuration data, resulting in subprocess errors, a result of undefined may be returned. Tests that don't run due to a daemon not running may implicitly store undefined result values.

A result of “failure due to lower level failure” may indicate the failure of one or more base tests that prevent the successful execution of a higher level test. For example, if a DNS lookup (base test) fails, then a ping by a particular hostname (higher level test) cannot complete. If more than one base test is required and a subset (e.g., one) of the required base tests fails, then the network tool 112 may indicate a failure due to lower level failure.

Any base tests required by a higher level test may be defined in the test configuration parameters for the higher level test. In some embodiments, a base test may be any test which is depended upon by at least one other test. In other embodiments, any test which requires no other tests in its configuration parameters may be considered a base test. A higher-level test may be a test which is not depended upon by other tests. Alternatively, any test which requires other tests may be considered a higher level test.

There may be a hierarchy of higher level tests, such that a first layer of tests may depend on base tests, and a second layer of tests depend on the first layer of tests. Failure at a low level of the hierarchy may propagate up to multiple higher layers of dependencies based on the hierarchy.

Base tests may be executed even if not required by the test configuration parameters provided in the configuration data. Rather, base tests may make use of parameters in the target network configuration parameters. Base tests may include tests such as 802.11Authentication, 802.11Association, DNS, DHCP, and SLAC. In further embodiments, base tests may include 802.1x Authentication, Internet—Bidirectional Traffic, and Corp (Bidirectional Traffic).

Some base tests may be configurable by a user (e.g., by the administrator 110). For example, the administrator may send a request indicating that test should be run with a certain configuration. For example, the request may specify that the DNS test should be run against a specific server, record, or type. This request may be sent, for example, to the cloud storage 114 where the cloud storage 114 may update the target network configuration parameters accordingly.

If the base tests are successful, higher level tests dependent on the base tests may be run. If the base tests are not successful, the higher level tests may be skipped. For example, in the event of a base test failure, higher level tests dependent on the base test may implicitly fail with a status code indicating lower level failure. Such higher level tests may include, for example, ping and HTTP.

Higher level tests may be user configurable. For example a user (such as the administrator 110) may send a request identifying a target and a protocol. If no protocol is specified, the protocol may default to IPv4. Other test parameters provided by the user may include test specific parameters (e.g., a URL for an http test).

The tests performed by the network tool may have full IPv4/IPv6 feature parity. For example in the presence of IPv4, the base tests may include DHCP. If IPv6 is enabled, the base tests may also include IPv6 Stateless Autoconfiguration.

At step 212, the test results and/or data associated with the performance metrics may be stored locally on the network tool (e.g., in an RRD in the local memory of the network tool, as described above). At step 214, the network tool 112 may determine whether there are any more tests to conduct in this particular wireless network 106 during this particular testing run. If the determination at step 214 is “yes” (i.e., there are more tests to conduct in this network), then processing may return to step 208, where the network tool 112 may retrieve the parameters for the next test from the configuration data provided at step 202. The network tool 112 may then perform the next test.

If the determination at step 214 is “no” (i.e., there are no more test to execute during this particular testing run), then processing may proceed to step 216 and the network tool 112 may disconnect from the wireless network 106. For example, the network tool 112 may free any network resources in use by the network tool 112, and may tear down any connections established by the network tool 112 using the wireless network 106. Processing may then proceed to step 218, where the network tool 112 determines whether there are any other wireless networks 106 that remain to be tested by the network tool 112. For example, the network tool 112, may consult the list of wireless networks to be tested as provided in the target network configuration parameters provided in the configuration data at step 202.

If the determination at step 218 is “yes” (more networks remain to be tested in this particular testing run), then processing may return to step 204 and the network configuration parameters for the next wireless network 106 may be processed from the configuration data provided at step 202. If the determination at step 218 is “no” (no networks remain to be tested in this particular testing run), then processing may proceed to step 220.

At step 220, the test results generated at step 210 for each test and each network may be merged for compact transmission to the cloud storage 114. For example, the network tool 112 may retrieve the results for each test within a particular network from the local storage and may merge the test results into a first data structure including a header identifying the network tested. The network tool may 112 may then retrieve the results for each test within the next network from the local storage, may merge the test results into a second data structure including another header identifying the network, and may append the second data structure to the first data structure. Once each of the tests for each of the networks has been retrieved, a cumulative data structure including all test results may be created. The cumulative data structure may be uploaded to the cloud storage 114 (and/or the central server 116) at step 222.

Once the test results are stored at the cloud storage 114, the test results may be retrieved by the central server 116. For example, the cloud storage 114 and/or the network device 112 may send an alert to the central server 116 informing the central server 116 that new test data is available. Alternatively or in addition, the central server 116 may periodically poll the cloud storage 114 and retrieve any new test data.

The central server 116 may perform trend analysis on the test data to identify trends within a wireless networks and across wireless networks in a given location. The central server 116 may send alerts to the administrator 110 based on the trend analysis and/or based on other analyses of the test data.

At step 224, the network tool may enter sleep mode. For example, the network tool may set a timer for a predetermined period of time (e.g., five minutes) and wait to execute a further test until the expiration of the timer. The predetermined period of time may be set or modified, either manually (e.g., by the network administrator), or automatically in accordance with conditions in the network and/or results of the test performed by the network tool or another network tool. While in sleep mode, the network tool may enable energy saving options in order to conserve power. After the expiration of the predetermined period of time, the network tool may awaken and return to step 202.

The network tool may also be prematurely awakened, for example by the network administrator using a remote login. Fore example, the network tool may maintain an active secure shell (SSH) server and may include a full suite of network testing tools to allow network operators to connect to the device remotely and execute arbitrary tests. In this case, the network administrator may direct the network tool to perform particular selected tests for a given network, and the network tool may execute appropriate steps to complete the requested tests and report the results of the tests back to the administrator.

In order to further support the troubleshooting functionality of the network tool, the network tool may be programmed with one or more troubleshooting tools having the ability to perform manual triage functions. For example, the network tool may include a tcpdump analyzer, and a ping/traceroute tool.

In one embodiment, the step 224 of entering sleep mode may not be carried out. This allows the network tool 112 to serve in an “always on” capacity, in which the device is constantly performing tests. This allows the network tool 112 to better target the troubleshooting of chronic but intermittent problems in an area, and allows the network tool 112 to record any problems that might occur in the network (thereby reducing the need for an end-user to attempt to recreate the problem for a technician).

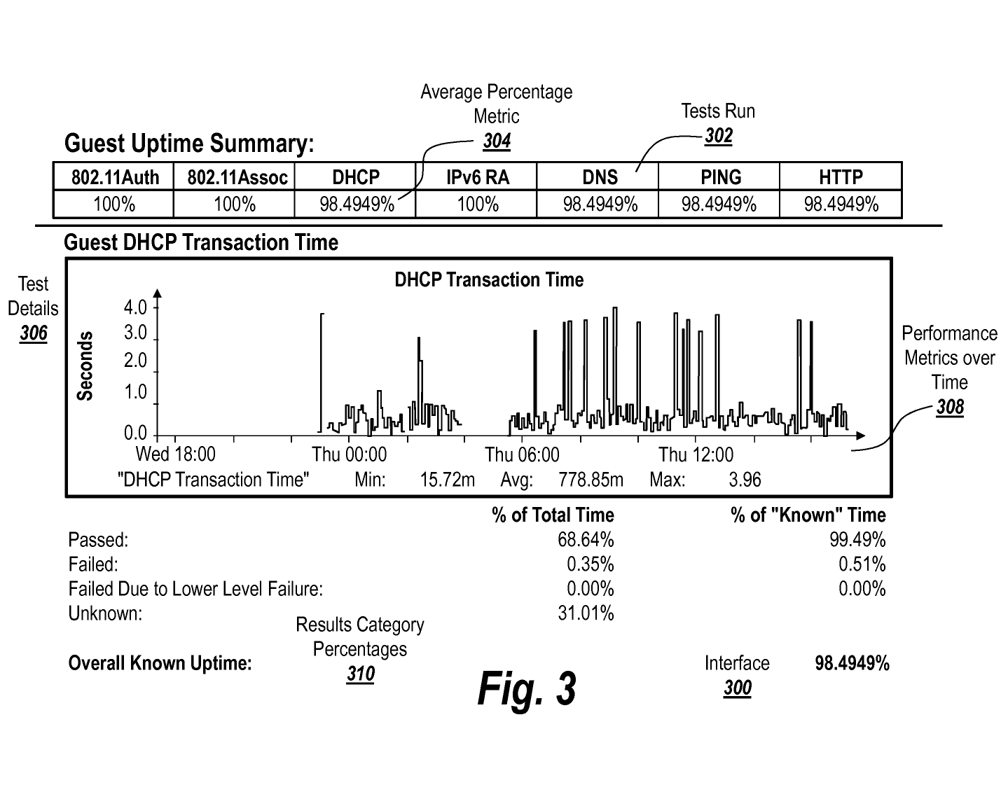

By performing the above steps, the network tool 112 may generate test results and performance metrics for analysis by the central server 116. The central server 116 may perform trend analysis, alerting, and/or reporting of the test results and/or performance metrics, for example by providing an analysis, alerts, and/or reports to the administrator 110. FIG. 3 is an exemplary interface 300 for displaying test results and performance metrics.

The interface may display the identifiers of any tests run 302 and the average performance metrics 304 over a given time period (the time period may be a default time period, or may be specified by a user such as the administrator 110). The interface may also display more detailed test results in a test details view 306. The test details view 306 may include, for example, the metrics for a particular test over a period of time 308, and the percentage of results falling into a particular results category 310 (e.g., success, failure, failure due to lower level failure, or unknown). In one embodiment, selecting a test in the list of tests run 302 may cause the test details view 306 to update with the performance metrics of the selected test.

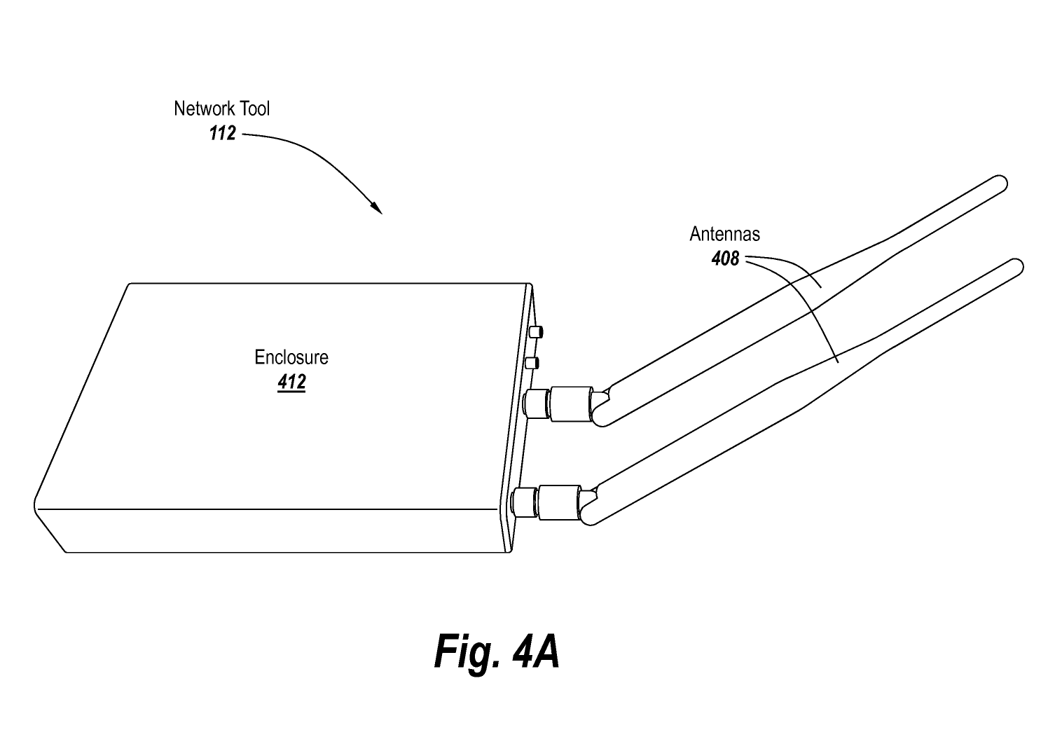

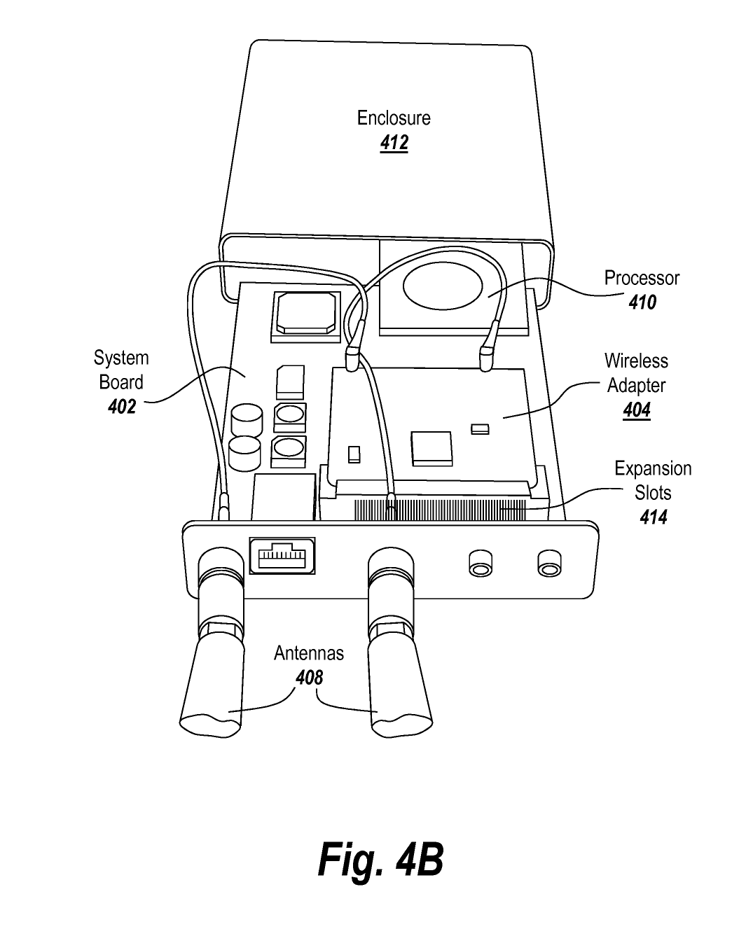

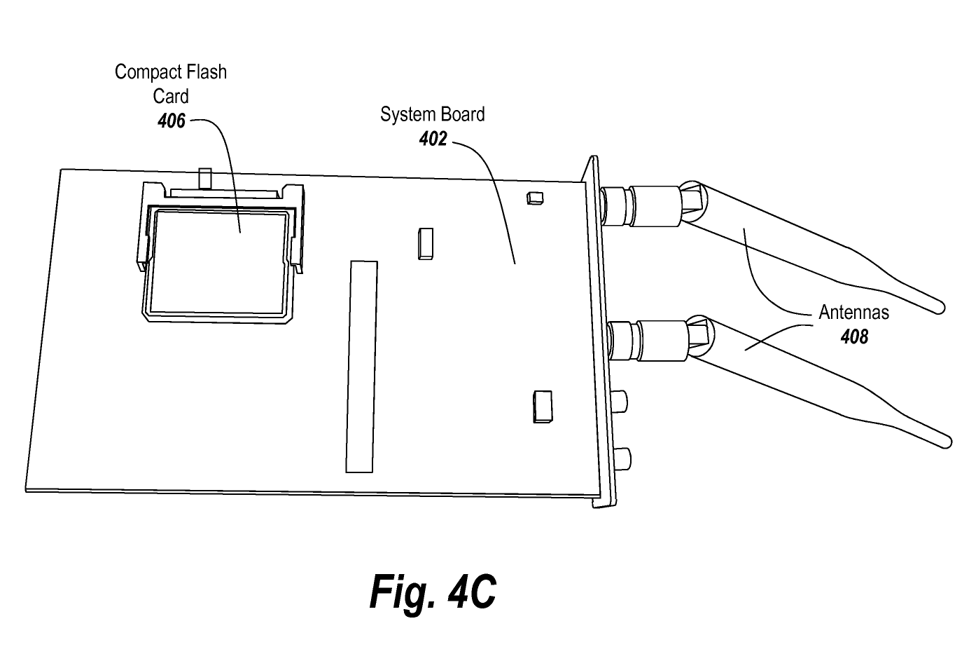

The network tool 112 may include suitable hardware and/or software for carrying out the above-described acts. For example, as shown in FIGS. 4A-4B, an exemplary network tool 112 may be an embedded systems device. An embedded system may be a computing system having a dedicated function or being designed to handle a specific task, as opposed to a general purpose computing device. The reduced processing, memory, and storage requirements of an embedded device make such a platform small and cost effective.

The embedded device may include a system board 402, a wireless adapter card 404 and/or a wired connection such as an Ethernet port, a memory 406 (such as a compact flash or “CF” card) for local storage, a power source, two tuned antennas 408, a processor 410, and an enclosure 412 holding the system.

An example of a system board 402 suitable for use with exemplary embodiments, as shown in FIGS. 4B-4C, is the ALIX3d2 system board by PCEngines GmbH of Glattbrugg, Switzerland. An exemplary wireless adapter 404 suitable for use with exemplary embodiments, visible in FIG. 4B, is the R52nM adapter by MikroTik Ltd. of Riga, Latvia. One of ordinary skill in the art will recognize that other suitable components, besides those listed above, may be employed in the network tool 112.

In some embodiments, the embedded device may include one or more pluggable expansion slots 414, such as mini peripheral component interconnect (mPCI) slots, to provide an upgrade path in support of future changes in deployed wireless technologies.

The embedded device may include a wireless module add-on running the Linux operating system. The operating system may be stored, for example, in the memory 406. The size of the memory 406 may be selected based on the size of the operating system, the size of the local storage needed to store the temporary test data (e.g., seven days' worth of test data), the size of utilities for monitoring and troubleshooting the wireless network 106 and the network tool 112, and any excess capacity desired by the administrator.

The memory 406 may further store one or more utilities for troubleshooting and/or debugging the network tool 112. Such utilities may include, for example, command line utility support components such as ls, my, cp, ifconfig, etc. Moreover, in order to store the local data in a database, the memory 406 may further include a copy of a database tool, such as RRDtool.

Network troubleshooting and diagnostic utilities, such as busybox, curl, iperf, tcpdump, mtr, hping, rdisc, and other utilities may also be included in the memory 406 in order to provide manual network troubleshooting capabilities for the administrator 110. Further, the memory 306 may store logic (such as daemons) and/or scripts for running tests on the network. Still further, the memory 406 may store services, such as ip(6)tables, ntpd, sshd, syslogd, klogd, dhcpcd, and crond.

In exemplary embodiments, the above-described combination of hardware and software allows the network tool to function in an arbitrary wireless network, where the network tool is agnostic to the particular infrastructure vendor used to provide the network.

One or more of the above-described acts may be encoded as computer-executable instructions executable by processing logic. The computer-executable instructions may be stored on one or more non-transitory computer readable media. One or more of the above described acts may be performed in a suitably-programmed electronic device.

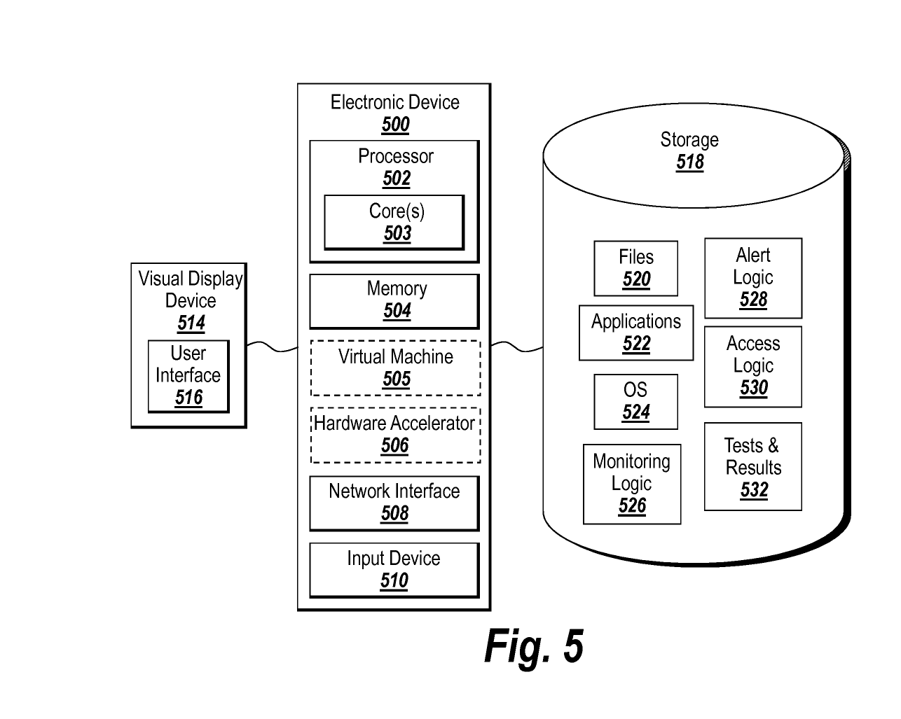

In addition or as an alternative to the embodiments already discussed, one or more of the above-described acts may be encoded as computer-executable instructions executable by processing logic. FIG. 5 depicts an example of an electronic device 500 that may be suitable for use with one or more acts disclosed herein.

The electronic device 500 may take many forms, including but not limited to a computer, workstation, server, network computer, quantum computer, optical computer, Internet appliance, mobile device, a pager, a tablet computer, a smart sensor, application specific processing device, etc.

The electronic device 500 is illustrative and may take other forms. For example, an alternative implementation of the electronic device 500 may have fewer components, more components, or components that are in a configuration that differs from the configuration of FIG. 5. The components of FIG. 5 and/or other figures described herein may be implemented using hardware based logic, software based logic and/or logic that is a combination of hardware and software based logic (e.g., hybrid logic); therefore, components illustrated in FIG. 5 and/or other figures are not limited to a specific type of logic.

The processor 502 may include hardware based logic or a combination of hardware based logic and software to execute instructions on behalf of the electronic device 500. The processor 502 may include logic that may interpret, execute, and/or otherwise process information contained in, for example, the memory 504. The information may include computer-executable instructions and/or data that may implement one or more embodiments of the invention. The processor 502 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. The processor may include a single core or multiple cores 503. Moreover, the processor 502 may include a system-on-chip (SoC) or system-in-package (SiP).

The electronic device 500 may include one or more tangible non-transitory computer-readable storage media for storing one or more computer-executable instructions or software that may implement one or more embodiments of the invention. The non-transitory computer-readable storage media may be, for example, the memory 504 or the storage 518. The memory 504 may comprise a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

One or more computing devices 500 may include a virtual machine (VM) 505 for executing the instructions loaded in the memory 504. A virtual machine 505 may be provided to handle a process running on multiple processors so that the process may appear to be using only one computing resource rather than multiple computing resources. Virtualization may be employed in the electronic device 500 so that infrastructure and resources in the electronic device may be shared dynamically. Multiple VMs 505 may be resident on a single computing device 500.

A hardware accelerator 506, may be implemented in an ASIC, FPGA, or some other device. The hardware accelerator 506 may be used to reduce the general processing time of the electronic device 500.

The electronic device 500 may include a network interface 508 to interface to a Local Area Network (LAN), Wide Area Network (WAN) or the Internet through a variety of connections including, but not limited to, standard telephone lines, LAN or WAN links (e.g., T1, T3, 56kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 508 may include a built-in network adapter, network interface card, personal computer memory card international association (PCMCIA) network card, card bus network adapter, wireless network adapter, universal serial bus (USB) network adapter, modem or any other device suitable for interfacing the electronic device 500 to any type of network capable of communication and performing the operations described herein.

The electronic device 500 may include one or more input devices 510, such as a keyboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 500 may include other suitable I/O peripherals.

The input devices 510 may allow a user to provide input that is registered on a visual display device 514. A graphical user interface (GUI) 516 may be shown on the display device 514.

A storage device 518 may also be associated with the computer 500. The storage device 518 may be accessible to the processor 502 via an I/O bus. The information may be executed, interpreted, manipulated, and/or otherwise processed by the processor 502. The storage device 518 may include, for example, a storage device, such as a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the invention

The storage device 518 may store one or more files 520, and may further store applications 522 and an operating system (OS) 524. Examples of OS 524 may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile electronic devices, or other operating system capable of running on the electronic device and performing the operations described herein. The operating system may be running in native mode or emulated mode.

The storage device 518 may further store monitoring logic, such as logic for performing the steps described in FIG. 2. The storage device 518 may store alert logic 528, which may compare the test results (categorical results and/or performance metrics) to predetermined evaluation metrics and create and send an alert if the test results indicate a problem with the network. The storage device 518 may store access logic 530, which may allow the administrator 110 to access the electronic device 500 and manually perform network tests. Furthermore, the storage device 518 may store the tests to be run and the results of the tests 532, for example in a database.

One or more embodiments of the invention may be implemented using computer-executable instructions and/or data that may be embodied on one or more non-transitory tangible computer-readable mediums. The mediums may be, but are not limited to, a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), a magnetic tape, or other computer-readable media.

Although exemplary embodiments have been described in connection to a wireless network, these embodiments are also deployable in a wired network. Furthermore, the network tool 112 could be deployed solely in a wireless network 106 without the addition of cloud storage 114 or a central server 116.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of an electronic device, unless otherwise stated.

It is intended that the invention not be limited to the particular embodiments disclosed above, but that the invention will include any and all particular embodiments and equivalents falling within the scope of the following appended claims.

1. A system comprising:
a transmitter for directly connecting to a wireless network as a client of the wireless network, a memory for storing:
one or more tests for determining a status of the wireless network, and configuration data for the one or more tests; and
a processor configured to:
execute a command to run the one or more tests according to the configuration data,
generate results for the one or more tests,
store the result of each test locally in the memory,
parse the results to determine if each test was successful, and
transmit the results to a storage device located outside the wireless network.

2. The system of claim 1, wherein the processor is further configured to:
request the configuration data from a cloud storage device located outside the wireless network.

3. The system of claim 2, wherein the processor authenticates the system with the cloud storage device.

4. The system of claim 1, wherein the system uploads the results of the tests to a cloud storage device located outside the wireless network.

5. The system of claim 1, further comprising antennas for connecting to the wireless network and retrieving the configuration data, wherein a number of the antennas is two.

6. The system of claim 1, wherein the one or more tests are run in a predetermined order.

7. The system of claim 1, wherein the configuration data comprises performance metrics for the tests, and the configuration data defines which performance metrics must be met to result in a test success.

8. The system of claim 7, wherein:
the tests comprise at least one base test and at least one high level test dependent on a successful result of the base test,
the processor determines that the base test has failed, and
the processor skips the high level test and stores a result indicating that the high level test failed due to the failure of the base test.

9. The system of claim 7, wherein:
the tests comprise at least one base test and at least one high level test dependent on a successful result of the base test,
the processor determines that the base test has succeeded, and
the processor runs the high level test based on the success of the base test.

10. The system of claim 1, further comprising:
a cloud storage for retrieving the results of the tests from the memory, and
a central server configured to:
retrieve the results of the tests from the cloud storage, and
perform a trend analysis on the results.

11. A system comprising:
a memory for storing one or more tests for determining a status of a wireless network;
an interface for allowing a remote connection from outside the wireless network;
a processor configured to:
receive an instruction originating outside the wireless network via the interface, the instruction requesting that a specified test be performed;
perform the test to generate test results; and
forward the test results in response to the request.

12. The system of clam 11, wherein the system is an embedded system.

13. The system of claim 11, wherein the system connects to the wireless network as a client of the wireless network.

14. The system of claim 11, further comprising antennas for connecting to the wireless network, wherein a number of the antennas is two.

15. The system of claim 11, wherein the processor is further configured to:
perform one or more tests of the wireless network at predetermined time intervals, and
enter a sleep mode between the predetermined time intervals, wherein:
the processor wakes up from the sleep mode in response to receiving the instruction.

16. The system of claim 15, wherein:
the memory further stores a lock flag indicating that a test is being performed on the wireless network, and
the processor is further configured to check for the lock flag before performing any action that would tear down an existing network connection.

17. A method comprising:
retrieving, using a processor of an embedded system, configuration data, wherein the configuration data comprises:
device data for configuring the embedded system,
network connection data for connecting to one or more wireless networks, and
test configuration data for performing one or more tests on the one or more wireless networks;
connecting to a first wireless network from among the one or more wireless networks specified in the network connection data, wherein the embedded system connects to the wireless network as a client of the wireless network;
performing the one or more tests specified in the test configuration data to generate results;
merging the results;
storing the results in a local storage of the embedded system; and
transmitting the results to a location outside of the first wireless network.

18. The method of claim 17, wherein the step of retrieving the configuration data comprises:
establishing a connection to a cloud storage device,
identifying the embedded system, and
retrieving a configuration file assigned to the embedded system from the cloud storage device.

19. The method of claim 17, wherein the configuration data further comprises performance metrics for determining whether a given test was successful.

20. The method of claim 17, further comprising:
receiving an instruction to perform a specified test from a location outside of the first wireless network;
performing the specified test to generate specified test results; and
transmitting the specified test results to the location outside of the first wireless network.
